(19) United States
(12) Patent Application Publication
(10) Pub. No.: US 2025/0333251 A1
(43) Pub. Date: Oct. 30, 2025

(54) FRAME LOCK

(71) Applicant: A. G. Stacker Inc., Weyers Cave, VA (US)

(72) Inventors: Dalton HEGE, Weyers Cave, VA (US); Randall Donn SENGER, Mount Sidney, VA (US); Eric STEMPIHAR, Rockingham, VA (US); Joseph WUNDER, Lexington, VA (US)

(21) Appl. No.: 19/187,147

(22) Filed: Apr. 23, 2025

Related U.S. Application Data
(60) Provisional application No. 63/639,299, filed on Apr. 26, 2024.

(51) Int. Cl. B65G 41/00

(52) U.S. Cl. CPC B65G 41/002; B65G 41/007; B65G 2203/0283; B65G 2207/40

(57) ABSTRACT

A frame system include first and second frame members and a locking system for locking the second member against movement in a first direction relative to the first member. The locking system includes a follower arm pivotably connected to the second member and a follower pin on the follower arm. The first member has guide surfaces configured to guide movement of the pin and a cradle for receiving the pin. The pin and the guide surfaces are configured such that moving the second frame member moves the follower pin along a predefined closed path that includes the cradle, and the cradle and follower arm are configured such that when the follower pin is in the cradle, movement of the second member in the first direction is prevented until the second member is moved in the second direction to remove the pin from the cradle.

### CROSS-REFERENCE TO RELATED APPLICATIONS

This application claims the benefit of U.S. Provisional Patent Application No. 63/639,299, filed Apr. 26, 2024, the entire contents of which are hereby incorporated by reference.

### TECHNOLOGICAL FIELD

The present disclosure is directed to a locking device for holding a first frame member in a given orientation or position relative to a second frame member when the second frame member is mounted for pivotal or linear movement relative to the first frame member.

### BACKGROUND

Various machines have frame portions that can be pivoted or moved linearly and that sometimes need to be secured in a given relative position. This is especially important when one of the frame portions needs to be raised and held at a higher position than another frame portion. As a specific example, some conveyors include at least one upper deck having belts or wheels and a lower deck having belts or wheels, the upper and lower decks defining between them a sheet transport path for moving sheets of material from an upstream end of the conveyor to a downstream end of the conveyor. When it is necessary to access the interior of the conveyor, for cleaning or maintenance for example, the upper deck, or at least a portion of the upper deck, can be pivoted relative to the lower deck to expose the interior of the conveyor. (Other machines may have upper decks that can be raised and lowered relative to a lower deck along a linear path, either during operation or for purposes of cleaning and/or maintenance.)

The upper deck may be very heavy, and care must be taken to ensure that the upper deck is held securely in the raised position to avoid damage to the conveyor that could be caused by the upper deck falling in an uncontrolled manner toward the lower deck and, more importantly, to avoid injuring any worker who may have part of their body between the raised upper deck and the lower deck during a cleaning or maintenance procedure.

In other cases, a cover may be mounted for pivotal or linear movement relative to a machine housing or enclosure. In such cases too, it is important to hold the cover securely in the raised position, especially when the cover is heavy enough to cause damage or injury if it falls in an uncontrolled manner.

There are many conventional ways of accomplishing such a locking function. However, many conventional methods require an inconvenient insertion of locking pins and/or the use of powered actuators that could fail if power is removed from the locking system. It would therefore be desirable to provide a system for locking one frame member relative to another frame member that avoids these shortcomings.

### SUMMARY

The present disclosure is directed to a locking device for holding one component in a raised position relative to the ground or relative to a second component. While embodiments of the invention described herein relate to a conveyor having a pivotably mounted upper deck and a machine having a vertically movable upper deck, the locking device can be used with any mechanical system that includes one component that is pivotable or movable linearly between first and second positions, and especially between raised and lowered positions.

A first aspect of the disclosure comprises a frame system that includes a first frame member and a second frame member mounted for pivotal or linear movement in a first direction and in a second direction relative to the first frame member. The frame system also includes a locking system configured to selectively prevent the movement of the second frame member in the first direction, and the locking system comprises a follower arm having a first end portion and a second end portion and a follower pin, the first end portion being pivotably connected to the second frame member for pivotal movement about a first pivot axis, and the follower pin extending from the second end portion in a direction toward the first frame member. A plurality of guide surfaces are provided on the first frame member that are configured to guide movement of the follower pin during the movement of the second frame member in the first direction and in the second direction relative to the first frame member, and a first one of the guide surfaces delimits a cradle that is open in the second direction. The follower pin and the plurality of guide surfaces are configured such that the movement of the second frame member in the first direction and in the second direction relative to the first frame member moves the follower pin along a predefined closed path in a first direction from a starting point back to the starting point, and the predefined closed path extends into the cradle. Furthermore, the cradle and the follower arm are configured such that when the follower pin is moved into the cradle, further movement of the second frame member in the first direction is prevented until the second frame member is moved in the second direction to remove the follower pin from the cradle.

### BRIEF DESCRIPTION OF THE DRAWINGS

FIG. 1 is a perspective view of an upper deck of a conveyor supported by a frame and shows a pivotably mounted front upper deck and a pivotably mounted rear upper deck each held in a raised position by two locking devices according to the present disclosure.

FIG. 2 is a perspective view of one side of the frame of the conveyor of FIG. 1 with the front and rear upper conveyor decks removed for clarity and showing guide body portions of two of the locking devices of FIG. 1 mounted to two portions of the frame.

FIGS. 3A and 3B are perspective views of the front upper deck and the rear upper deck of the conveyor of FIG. 1 separated from the frame and showing the follower arms and follower pins of the two locking devices of FIG. 1 mounted to the front upper deck and the rear upper deck of the conveyor.

FIG. 4A is a side-elevational view of the guide body portion of the locking device of the present disclosure with a pivotable flap of the device in a closed position.

FIG. 4B is a side elevational view of the guide body portion of the locking device of FIG. 4A with the pivotable flap of the device in an open position.

FIG. 5 is a side elevational view of a portion of the conveyor of FIG. 1 and a locking device according to the present disclosure with the front upper deck in a fully lowered first position relative to the frame and the follower pin in a first location on the guide body.

FIG. 6 is a side elevational view of a portion of the conveyor and the locking device of FIG. 5 with the upper deck in a partially raised second position relative to the frame and the follower pin in a second location on the guide body.

FIG. 7 is a side elevational view of a portion of the conveyor and the locking device of FIG. 5 with the upper deck in a pre-locked raised third position relative to the frame and the follower pin in a third location on the guide body.

FIG. 8 is a side elevational view of a portion of the conveyor and the locking device of FIG. 5 with the upper deck in a locked raised fourth position relative to the frame and the follower pin in a fourth location on the guide body.

FIG. 9 is a side elevational view of a portion of the conveyor and the locking device of FIG. 5 with the upper deck in a post-locked raised fifth position relative to the frame and the follower pin in a fifth location on the guide body.

FIG. 10 is a side elevational view of a portion of the conveyor and the locking device of FIG. 5 with the upper deck in a mostly lowered sixth position relative to the frame and the follower pin in a sixth location on the guide body and immediately upstream of the pivotable flap.

FIG. 11 is a side elevational view of a portion of the conveyor and the locking device of FIG. 5 with the upper deck in a mostly lowered seventh position relative to the frame and the follower pin in a seventh location on the guide body and in contact with the gate.

FIG. 12 is a side elevational view of a portion of the conveyor and the locking device of FIG. 5 with the upper deck in a mostly lowered eighth position relative to the frame and the follower pin in a eighth location on the guide body immediately downstream of the pivotable flap.

FIG. 13 is a front elevational view of the frame and the upper conveyor decks of FIG. 1 with the front upper deck in a raised position.

FIG. 14 is a top plan view of the frame and the upper conveyor decks of FIG. 1.

FIG. 15 is front elevational view of the frame and the upper conveyor decks of FIG. 1 with the front upper deck in a lowered position.

FIG. 16 is a detail view of portion XVI of FIG. 15.

FIG. 17 is a front elevational view of a device having a first frame member and a second frame member mounted for linear movement relative to the first frame member and two locking devices according to the present disclosure, the figure showing the second frame member in a first position relative to the first frame member.

FIG. 18 is a front elevational view of the device of FIG. 17 with the second frame member in a second position relative to the first frame member.

FIG. 19 is a front elevational view of the device of FIG. 17 with the second frame member in a third position relative to the first frame member.

### DETAILED DESCRIPTION

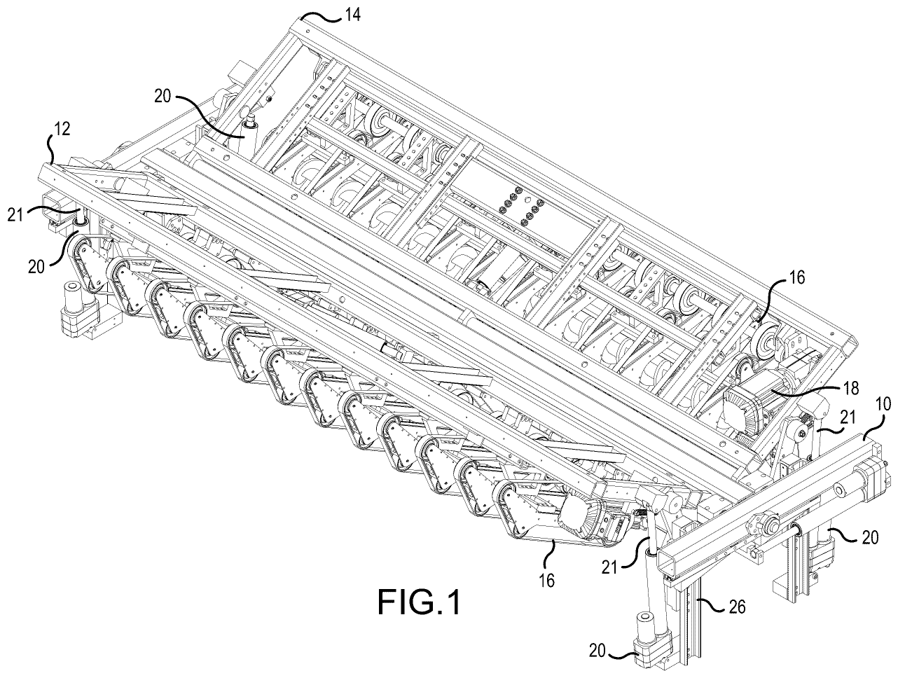

Referring now to the drawings, in which the showings are for purposes of illustrating presently preferred embodiments of the invention only and not for limiting same, FIG. 1 shows a fixed frame 10 of a conveyor system to which a front upper deck 12 and a rear upper deck 14 are pivotably mounted. The fixed frame 10 is an example of a first frame member according to the disclosure. The front upper deck 12 and the rear upper deck 14 are examples of second frame members according to the present disclosure. Each of the upper decks 12, 14 supports a plurality of belts 16 that are rotated by a drive 18. A lower conveyor deck, comprising wheels or belts for supporting sheets of material as they move through the conveyor beneath the belts 16, is normally present beneath the upper decks 12, 14, but is omitted from the drawings for clarity. FIG. 1 shows the upper decks 12, 14 in a raised position; when the decks 12, 14 are lowered, the belts 16 of the front and rear upper decks 12, 14 all lie substantially in a common plane.

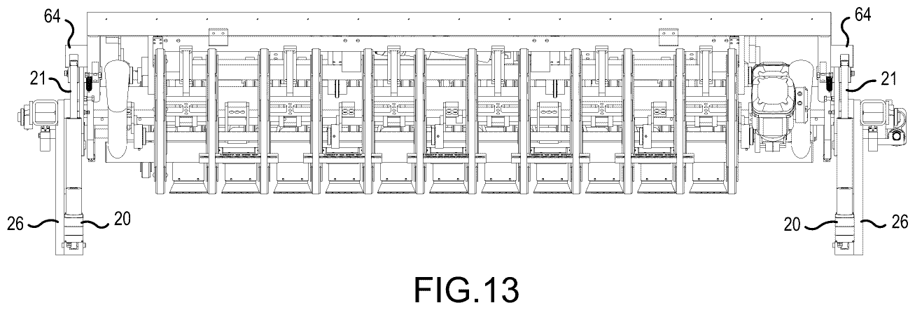

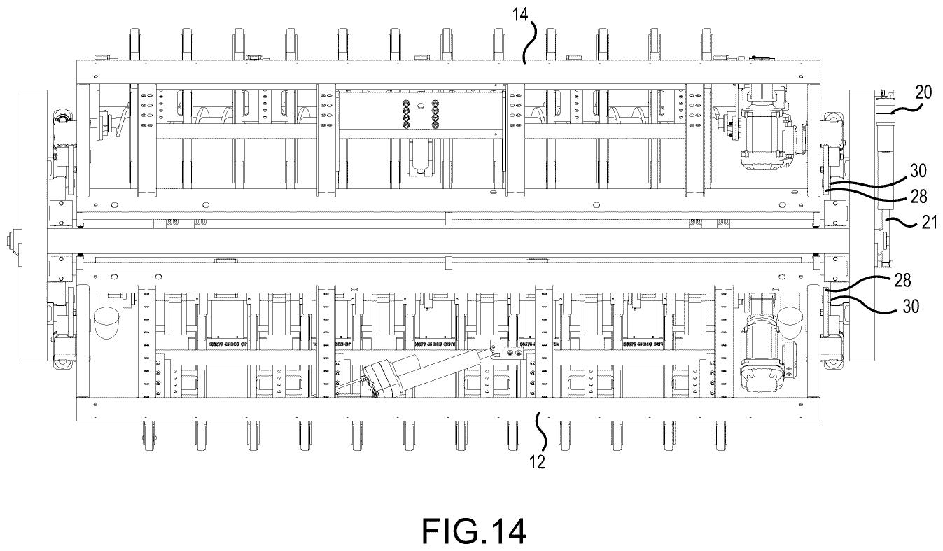

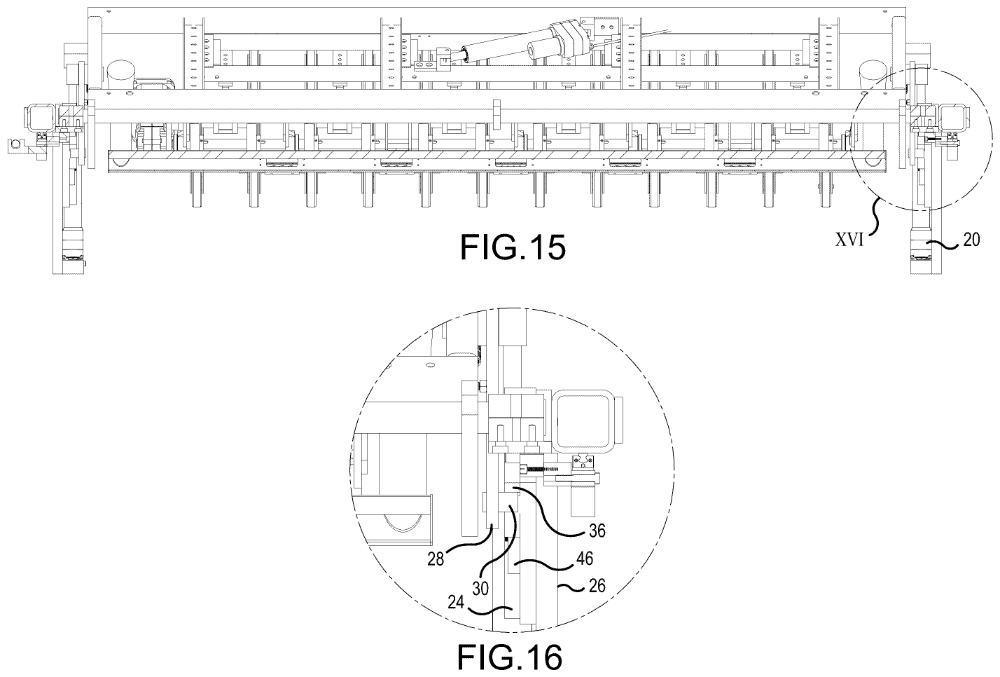

Each of the front and rear upper decks 12, 14 can be raised and lowered by a pair of actuators 20, electric or pneumatic or hydraulic, for example, having pistons 21, one at each side of each deck 12, 14 as shown in FIGS. 13-15. A locking device 22 is also provided near each of the actuators 20 for selectively locking one of the upper decks 12, 14 in the raised position. Because the front and rear upper decks 12, 14 are structurally the same and operate in the same manner, only the front upper deck 12 will be discussed hereinafter. Furthermore, because the actuators 20 and locking devices 22 on each side of the front upper deck 12 are also substantially identical (in some cases being mirror images of each other), only a single one of the actuators 20 and locking devices 22 will be described.

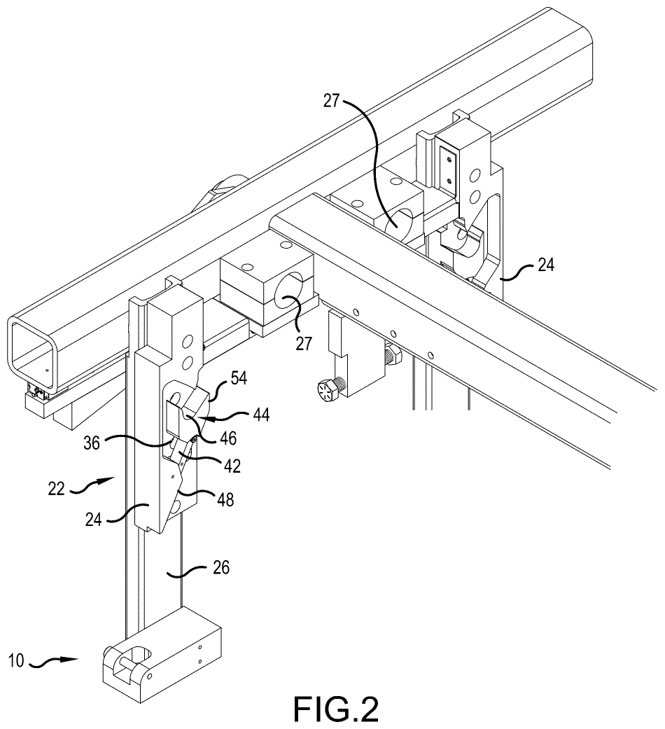

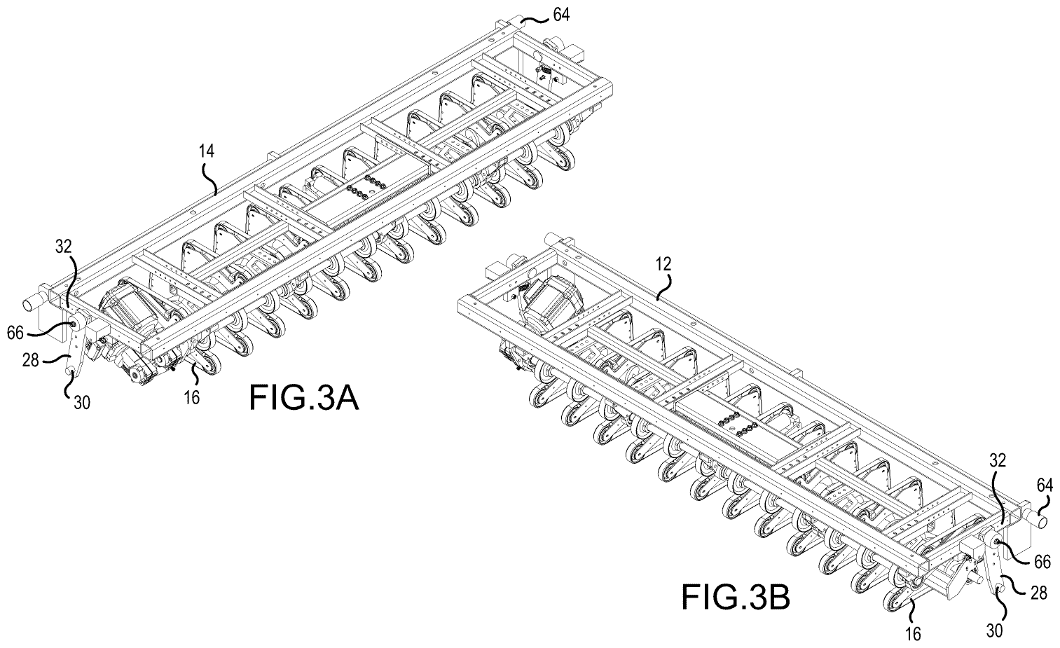

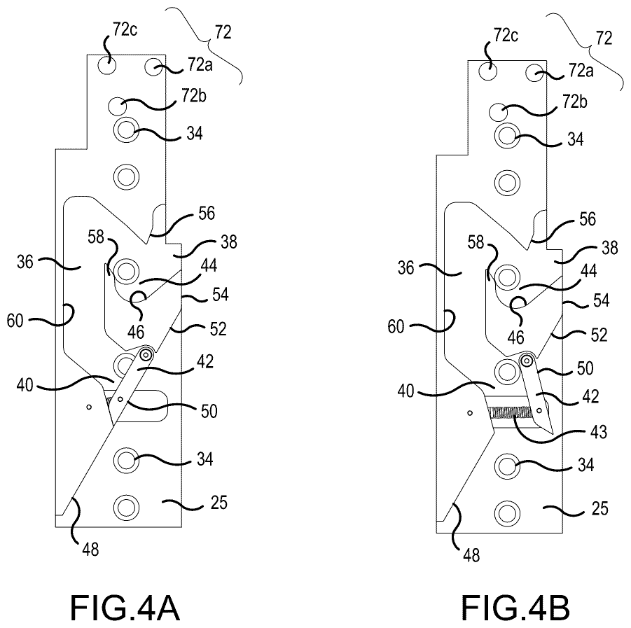

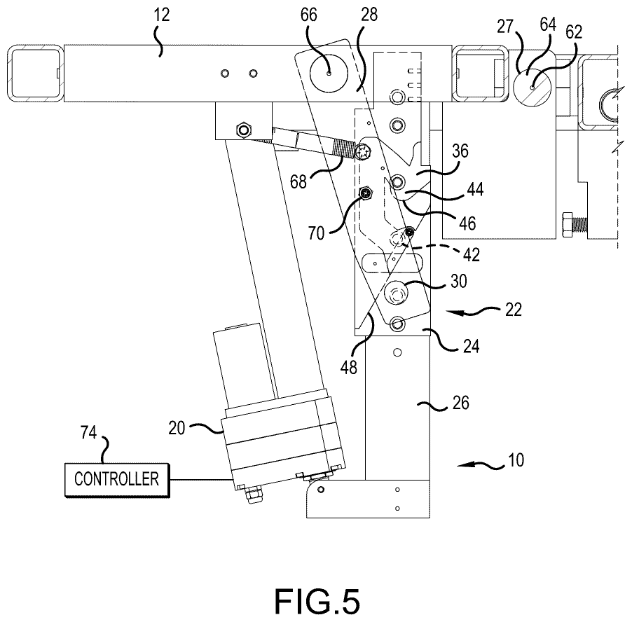

The locking device 22 includes a guide body 24 having a plurality of guide surfaces (discussed below), as shown for example in FIGS. 2, 4A and 4B, mounted to a vertical portion 26 of the fixed frame 10 and a follower arm 28 supporting a follower pin 30, as shown for example, in FIGS. 3A and 3B, pivotably mounted to a horizontal portion 32 of the front upper deck 12. While the preferred embodiments include a substantially vertical frame member 26 and ends of the upper decks 12, 14 moves generally up and down relative to the fixed frame member 10, the invention is not limited to any particular orientation of the first and second frame members or the locking device 22. That is, the locking device 22, illustrated for example in FIG. 5, could operate in any orientation, for example, upside down or after being rotated around any combination of three mutually perpendicular axes. Directional terms such as “vertical,” “horizontal,” “up,” and “down” are used herein for ease of reference to describe the disclosed embodiments which are shown to have vertical and horizontal frame members. These terms are not intended to limit the invention to use in the orientation shown in the Figures.

Furthermore, while the guide body 24 is shown as being attached to the fixed frame 10 and the follower arm 28 is mounted to the pivotable frame 12, these locations can be reversed so that the guide body 24 is located on a movable member and the pivot arm is mounted to a fixed frame member. Thus, the upper deck 12 is an alternate example of a “first frame member” and the fixed frame member 10 is an alternate example of a “second frame member” as used herein.

As illustrated in FIG. 4A, the guide body 24 includes a plurality of openings 34 for receiving fasteners (not illustrated) for connecting the guide body 24 to one of the vertical portions 26 of the frame 10. The guide body 24 defines a channel 36 and a plurality of guide surfaces for guiding the follower pin 30 at the free end of the follower arm 28. While the channel 36 and guide surfaces are formed on a guide body 24 mounted to the frame in this embodiment, the various guide surfaces could alternately be formed directly in the frame member 26. Furthermore, while a guide body 24 having a channel 36 is shown, only the portions of the channel 36 that are contacted by the follower pin 30 during operation of the locking device 22 are required to be provided. Thus a locking device according to the present disclosure could be formed with a plurality of discrete guide surfaces projecting from a frame member and without any structure that has the appearance of a continuous channel as shown in the present embodiment as long as a guide surface is present in each location as necessary to constrain the movement of the follower pin 30 along a closed path as described herein.

The channel 36 includes a first end 38 (“upstream end”) and a second end 40 (“downstream end”), the second end 40 being selectively closable by a spring-biased pivotably mounted flap 42 that is shown in a closed position in FIG. 4A and an open position in FIG. 4B. While a pivotably mounted flap 42 is shown, another flap or web structure that allows for movement of the follower pin 30 in one direction while preventing its return along the same path could be used without departing from the scope of the present invention. The flap 42 is biased toward the closed position by a spring 43.

The guide body 24 includes a cradle 44 delimited by a first guide surface 46. A second guide surface 48 is located below the second end 40 of the channel 36, a third guide surface 50 is located on a downstream surface of the flap 42, and a fourth guide surface 52 is located above the flap 42 between the second end 40 of the channel 36 and the first end 38 of the channel 36. A vertical guide surface 54 is located between the fourth guide surface 52 and the first end 38 of the channel 36; however, in some embodiments the fourth guide surface 52 could extend from the second end 40 of the channel 36 to the first end 38 of the channel 36, and the vertical guide surface 54 could be omitted. In the alternative, more than two guide surfaces and/or a curved guide surface could be provided between the first end 38 and second end 40 of the channel. A stop surface 56 extends into the channel 36 from a side of the channel 36 opposite the vertical guide surface 54, a wall 58 extends into the channel 36 from a downstream side of the cradle 44, and a fifth guide surface 60 extends generally vertically from a location above the cradle 44 to a location near the flap 42.

FIG. 5 is a side elevational view of the vertical portion 26 of the fixed frame 10 supporting the front upper deck 12 for pivotable movement around a pivot axis 62 of a journal 64 supported by the plain bearings 27 of FIG. 2. The actuator 20 is connected between the frame 10 and the front upper deck 12 for raising and lowering the front upper deck 12. The follower arm 28 is mounted to the front upper deck 12 so that it can pivot about a pivot axis 66. In this embodiment, the follower pin 30 is held against the first guide surface 46 of the locking device 22 by a spring 68 that rotationally biases the follower arm 28 in the clockwise direction. The spring 68 is required for the device to operate in certain orientations. However, in the orientation shown in the drawings, the spring 68 is optional because, due to the relationship between the axis of rotation 66 of the follower arm and the channel 36, the force of gravity alone is sufficient to cause the follower pin 30 to traverse the closed path in the manner described herein.

The guide channel 36 is open toward the viewer in FIG. 5, the follower arm 28 is located between the viewer and the guide body 24, and one end of the follower pin 30 is shown. The follower pin 30 extends into the page in FIG. 5 and so that it can contact the guide surfaces and travel along the channel 36 as discussed below. FIG. 16 also shows the follower pin 30 extending into the guide channel 36 and illustrates a degree of overlap between the follower pin 30 and the guide body 24.

The follower arm 28 includes a proximity sensor 70 that is configured to detect the presence of targets 72 (72a, 72b, 72c) on the guide body 24 as the follower pin 30 moves around a closed path as described below. The proximity sensor 70 may be, for example, an optical sensor in which case the targets 72 will be optical targets. The proximity sensor 70 could alternately comprise a magnetic sensor or other type of conventional sensor in which case the targets 72 will be of a type that can be sensed by the particular proximity sensor 70. The proximity sensor 70 is configured to output a signal to a controller 74 operably connected to the actuator 20 so that the actuator 20 can be controlled based on the position of the proximity sensor 70 relative to the targets 72 and thus the position of the follower pin 30 relative to the closed path, so that the actuator can be suitably controlled. In applications where the front upper deck 12 (or corresponding movable structure) is moved manually (without the use of an actuator 20) the proximity sensor 70 and targets 72 may be omitted because in this case the operator will be able to judge the location of the front upper deck 12 relative to the fixed frame member 10 visually.

As used herein, “closed path” should be understood to refer to a fixed series of locations traversed repeatedly by the follower pin as the second frame member moves relative to the first frame member. The closed path may have linear portions and/or curved portions and it encloses a non-zero area even though some portions of the path may overlap or be traversed in two directions or repeated as the follower pin travels from a starting position back to the starting position. For example, under this definition a follower pin moving in a circle traverses a closed path while a follower pin that merely moves back and forth in a straight line without enclosing an area does not. However, the closed path can have some portions that are traversed in two directions (such that a subsection of the closed path does not enclose an area). Thus, for example, with reference to a clock face, clockwise movement from 12 o'clock to 12 o'clock is a closed path as is clockwise movement from 12 o'clock to three o'clock, counterclockwise movement from 3:00 to 2:00 (on the same path), and then clockwise movement from 2:00 to 12:00. Finally, the closed path can have a linear portion that is traversed in two directions by the follower pin. With continued reference to a clock face, clockwise movement from 12:00 to 3:00, linear movement away from the clock face and back toward the clock face and continued clockwise movement from 3:00 to 12:00 is a closed path. The closed path thus may have overlapping portions but some portion of the path must also enclose an area.

FIG. 5 shows the upper front deck 12 in its fully lowered position in which the upper front deck 12 is substantially horizontal and the bottoms of the belts 16 (FIG. 1) lie in a horizontal plane. The upper front deck 12 is supported in this position by the actuator 20 and/or by other structures, not illustrated, that form a stop for the upper front deck 12 to prevent it from pivoting downward beyond the position illustrated in FIG. 5. The conveyor system that includes the front and rear upper decks 12, 14 operates in this configuration, and the front upper deck 12 is kept in the position shown in FIG. 5 at all times except when it is necessary to access the interior of the conveyor for cleaning, maintenance, removal of jammed material, etc.

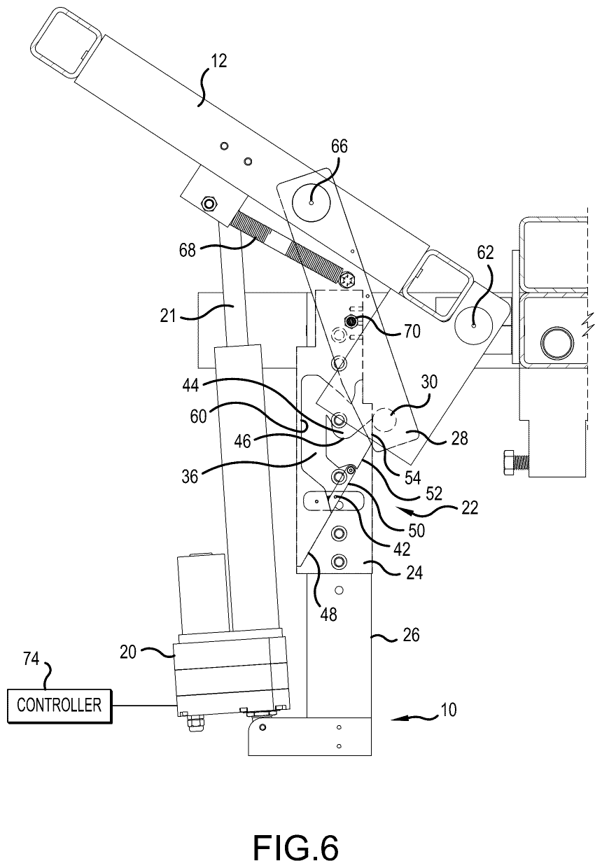

When it is desired to pivot the front upper deck 12 to a raised position, the controller 74 sends a signal to the actuator 20 to cause the actuator to extend the piston 21 and pivot the front upper deck 12 about the pivot axis 62. Shifting the front upper deck 12 from the position shown in FIG. 5 to the position shown in FIG. 6, causes the follower pin 30 to slide along the second guide surface 48 and onto the third guide surface 50 on the downstream surface of the flap 42 and from there to the fourth guide surface 52 and onto the vertical guide surface 54 between the fourth guide surface 52 and the first end 38 of the channel 36. Up to this point, the movement of the actuator 20 can be reversed to return the front upper deck 12 to the position of FIG. 5. With any additional extension of the piston 21, the front upper deck 12 and the follower pin 30 will be forced to move through a complete path (discussed below) before returning to the starting position of FIG. 5.

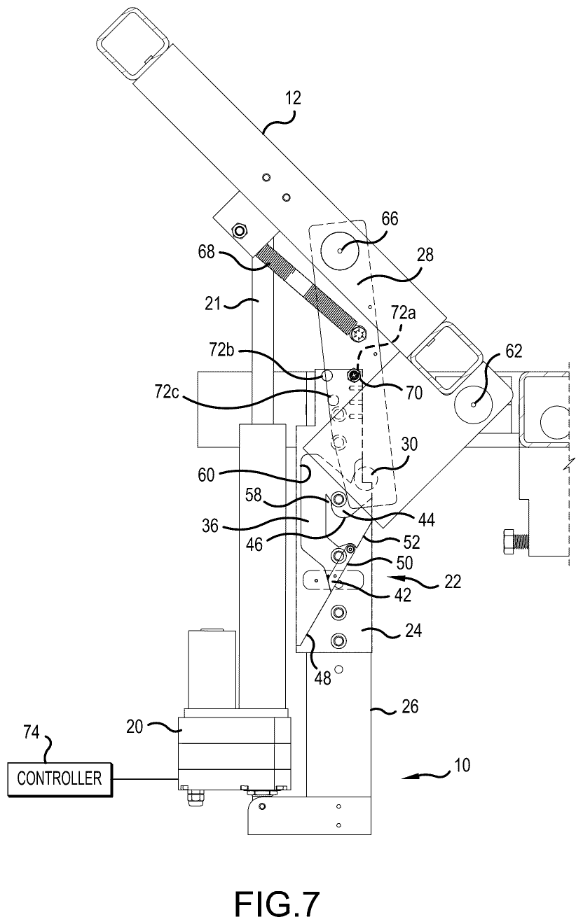

FIG. 7 shows how continued upward movement of the front upper deck 12 causes the follower pin 30 to move to a location above the upper end of the vertical guide surface 54 at which point the spring 68 pivots the follower arm 28 in a clockwise direction around the pivot axis 66 so that the follower pin 30 moves into the first end 38 of the channel 36 and into contact with the stop surface 56. In this position, the proximity sensor 70 is aligned with the first target 72a which indicates to the controller 74 that the front upper deck 12 is in a fully raised position and that the actuator 20 should now begin to lower the front upper deck 12 in order to continue to move the follower pin 30 along the closed path.

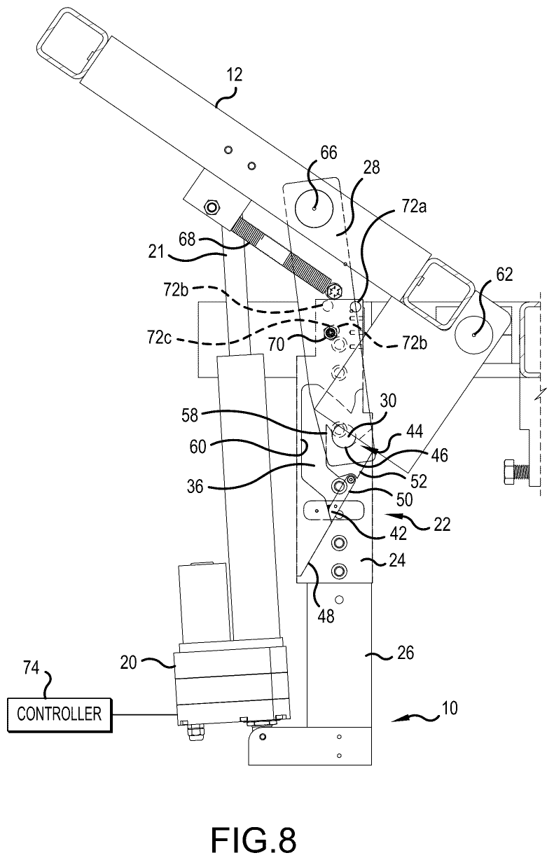

The stop surface 56 is configured such that when the front upper deck 12 is lowered from the position shown in FIG. 7 the follower pin 30 must enter the cradle 44 as shown in FIG. 8 because the follower pin will not be able to pivot past the wall 58. When the follower pin 30 enters the cradle 44, the proximity sensor 70 becomes aligned with a second target 72b. This indicates to the controller 74 that the front upper deck 12 is in a safe, locked, raised position. In this position, the locking device 22 supports the weight of the front upper deck 12 without the expenditure of further energy and will securely hold the front upper deck 12 in this position indefinitely even if power to the actuator 20 is disconnected. That is, the front upper deck 12 cannot move back to its lowered position without an application of additional energy to first lift the front upper deck 12 to remove the follower pin from the cradle 44 and to allow the follower pin 30 to continue to move along the closed path toward the starting position of FIG. 5. The front upper deck 12 is maintained in this position, with the follower pin 30 and much of the weight of the front upper deck 12 supported by the cradle 44 of the locking device 22, until it is desired to return the front upper deck 12 to its fully lowered position, and a worker can access the interior of the conveyor knowing that the front upper deck is secure.

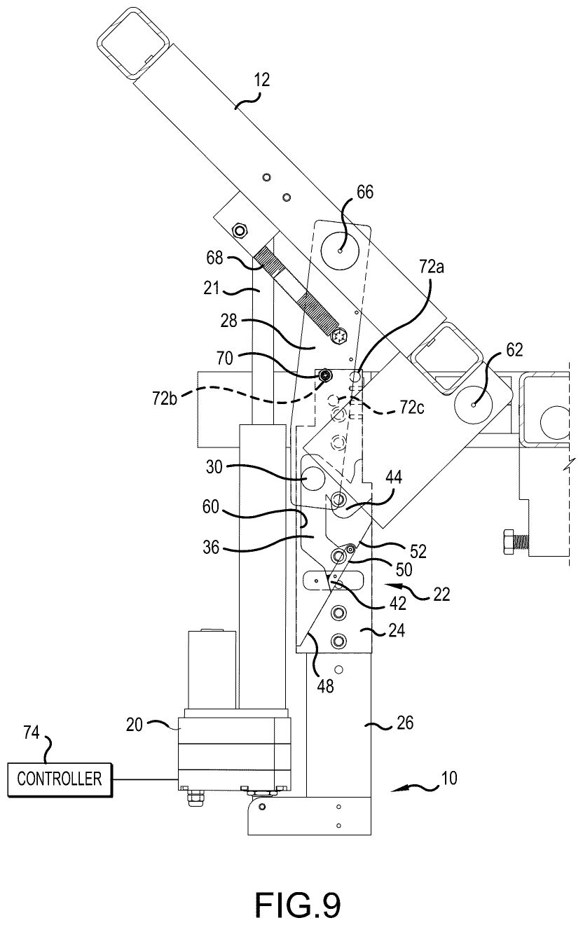

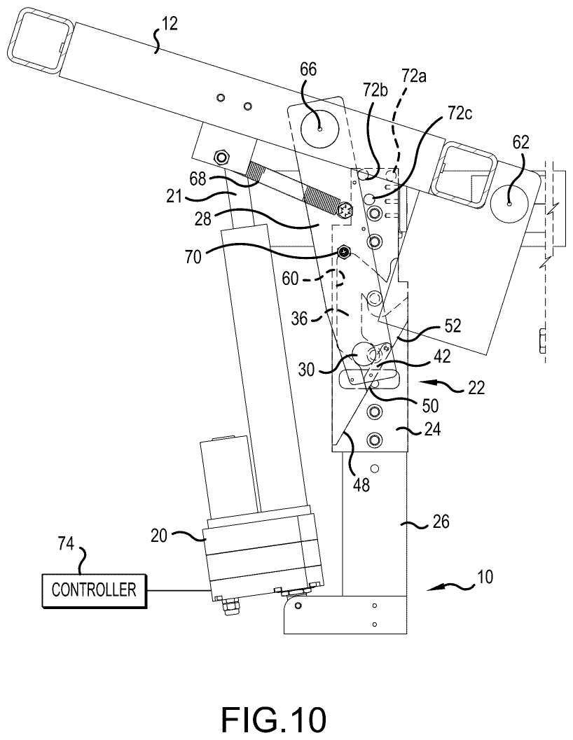

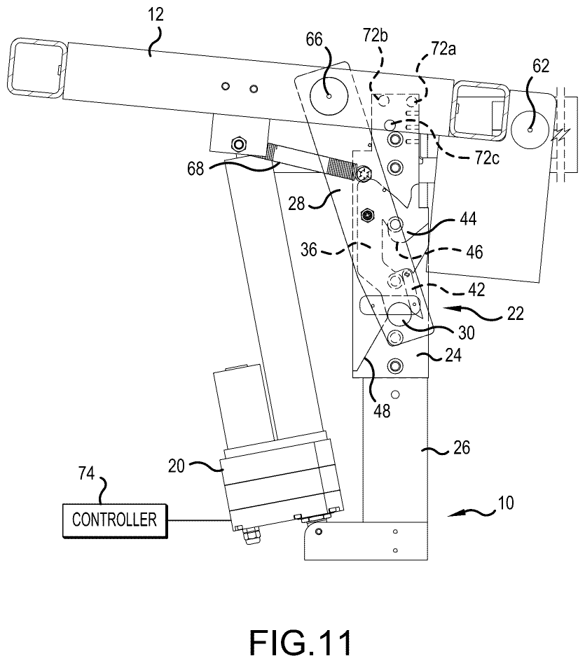

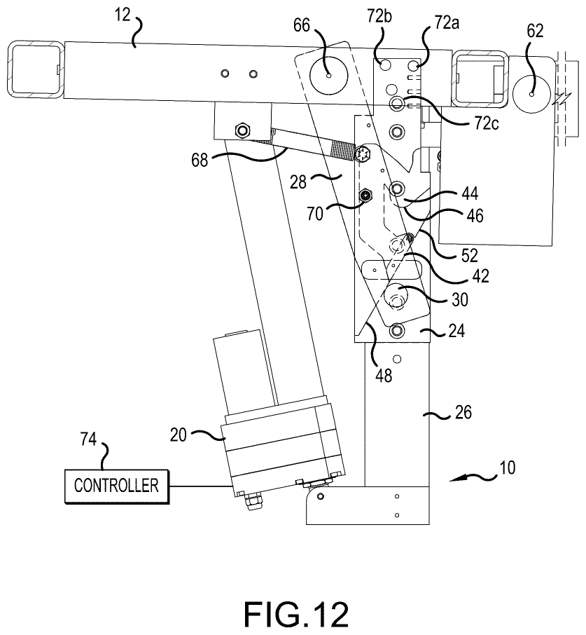

To lower the front upper deck 12, the controller 74 cause the actuator 20 to extend the piston 21 to raise the front upper deck 12 and move the follower pin 30 out of the cradle 44 until it clears the top of the wall 58 at which point the spring 68 pivots the follower arm 28 further in the clockwise direction until the follower pin 30 impacts against the generally vertical fifth guide surface 60 as shown in FIG. 9. In this position of the follower arm 28, the proximity sensor 70 is aligned with a third target 72c which indicates to the controller 74 that the front upper deck 12 does not need to be raised any further and that the front upper deck 12 can now be lowered. As the front upper deck 12 is lowered, the follower pin 30 moves downwardly along the channel 36 until it reaches the upstream side of the gate 42 as shown in FIG. 10. Further downward movement of the front upper deck 12 causes the follower pin 30 to press against and open the gate 42 (FIG. 11) and move through the gate 42 and onto the second guide surface 48 thereby allowing the gate 42 to be closed by the spring 43 as shown in FIG. 12, and the front upper deck 12 and the follower pin 30 are returned to their starting positions.

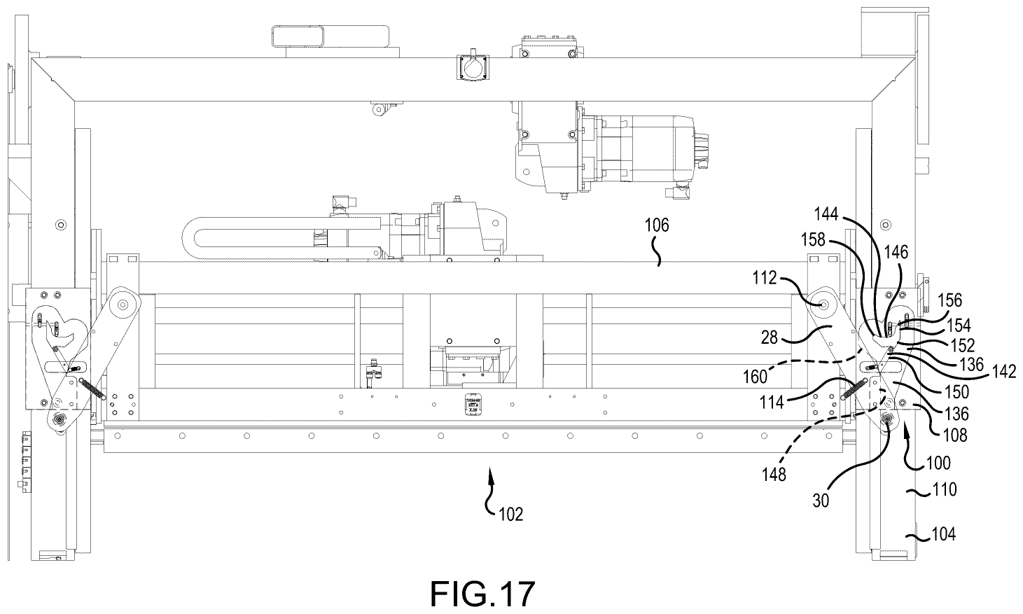

FIGS. 17-19 illustrate a second embodiment of a locking device 100 according to the present disclosure. Elements common to the first embodiment are identified with like reference numerals. Two locking devices 100 are illustrated in FIGS. 17-19 which are mirror images of each other. Because the devices 100 include the same elements and operate in the same manner, only the locking device 100 at the right side of FIG. 17-19 will be described.

The locking device 100 is configured for use with a machine 102 that has a fixed frame 104 and a movable frame 106 mounted on the fixed frame 104 for linear vertical movement relative to the fixed frame 104. As discussed above in connection with the first embodiment, the term “vertical” refers to the orientation of the machine 102 in FIGS. 17-19; however, the machine 102 could be rotated around any axis without affecting the function of the locking device 100.

The locking device 100 includes a guide body 108 mounted to a vertical member 110 of the fixed frame 104 and a follower arm 28 having a first end connected to the movable frame 106 for pivotal movement about an axis 112 and a second end having a projecting follower pin 30. A spring 114 biases the follower arm 28 in a clockwise direction and pulls the second end of the follower arm 28 toward a centerline of the machine 102.

The guide body 108 has a channel 136 that partly or fully defines a closed path to be followed by the follower pin 30 when the movable frame 106 moves relative to the fixed frame 104. A pivotably mounted flap 142 extends across a portion of the channel 136 and is biased into a closed position relative to the channel 136 as shown in FIG. 17 by a spring 143. The guide body 108 also includes a cradle 144 delimited by a first guide surface 146. A second guide surface 148 is located below the flap 142, a third guide surface 150 is located on a downstream surface of the flap 142, a fourth guide surface 152 is located above the flap 142, and a vertical guide surface 154 extends upward from the fourth guide surface 152. A stop surface 156 extends from a side of the channel 136 opposite the vertical guide surface 154 above the cradle 144, and a wall 158 extends upward from a downstream side of the cradle 144. A fifth guide surface 160 extends generally vertically from a first location above the cradle 144 to a second location near the flap 142. Sensors and sensor targets (not illustrated) as discussed in the first embodiment can be provided in appropriate locations and used to provide signals to a controller (not illustrated) to indicate a current position of the follower arm 28 and the follower pin 30.

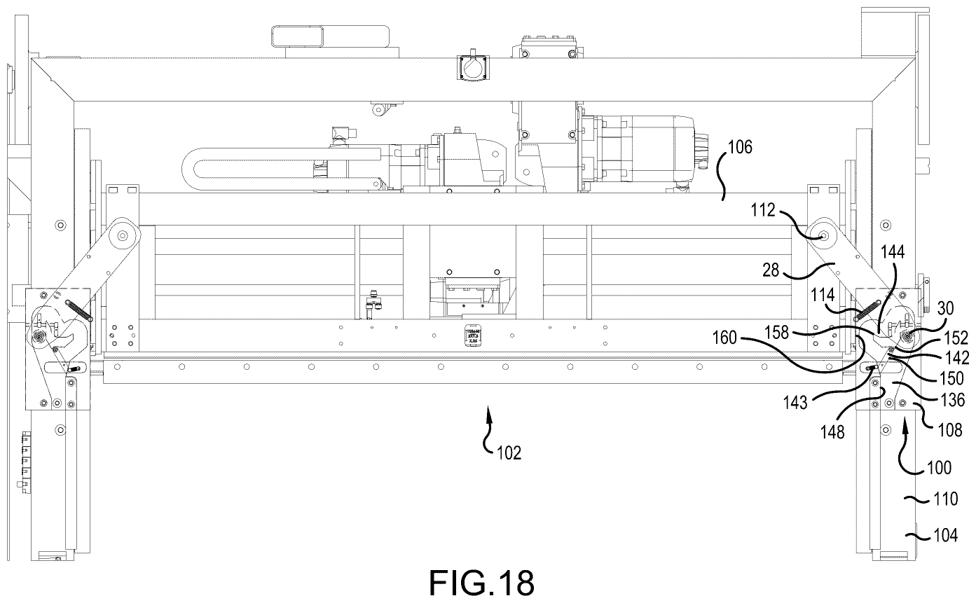

FIG. 17 shows the movable frame 106 in a starting or fully lowered position relative to the fixed frame 110 with the follower pin 30 in contact with the second guide surface 148. An actuator (not illustrated) raises the movable frame 106 vertically toward the position illustrated in FIG. 18 in which the follower pin 30 is in contact with the vertical guide surface 154, having traveled over the second guide surface 148, the third guide surface 150 and the fourth guide surface 152 in the process. As the movable frame 106 is raised further, the follower pin 30 is raised to a location above the upper end of the vertical guide surface 154, and the spring 114 pulls the follower arm 28 into a position above the cradle 144.

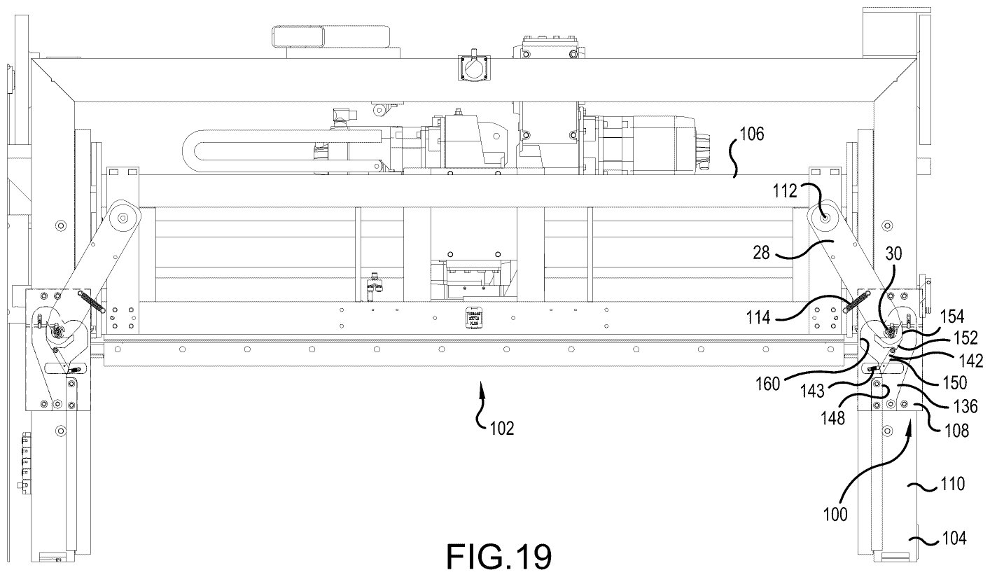

FIG. 19 shows that the movable frame 106 has been moved downward to move the follower pin 30 toward the first guide surface 146 in the cradle 144. Movement of the follower pin 30 out of the cradle 144 and around the channel 136 proceeds in the same manner as the movement of the guide pin 30 around the channel 36 of the first embodiment except that this movement is caused by a purely vertical movement of the pivot axis 112 at the end of the follower arm 28. In general, any movement of one frame member relative to another that causes the pivot axis of a follower arm on one of the members to move in a direction that has a vertical component can be used guide the follower pin 30 along a closed path in a locking body regardless of whether the follower arm pivot axis moves along a straight path or a curved path or a path having both curved and straight sections or even along a closed path such as a circle and regardless of which frame member is relatively fixed.

Embodiments of the present invention has been described above. However, modifications and additions to these embodiments will become apparent to persons of ordinary skill in the art upon a review of the foregoing description and drawings. It is intended that all such additions and modifications form a part of the present invention to the extent they fall within the scope of the several claims appended hereto.

What is claimed is:

1. A frame system comprising:
a first frame member,
a second frame member mounted for movement in a first direction and in a second direction relative to the first frame member, the movement being a pivotal movement or a linear movement, and
a locking system configured to selectively prevent the movement of the second frame member in the first direction, the locking system comprising:
a follower arm having a first end portion and a second end portion and a follower pin, the first end portion being pivotably connected to the second frame member for pivotal movement about a first pivot axis, and the follower pin extending from the second end portion in a direction toward the first frame member, and
a plurality of guide surfaces on the first frame member configured to guide movement of the follower pin during the movement of the second frame member in the first direction and in the second direction relative to the first frame member, a first one of the guide surfaces delimiting a cradle open in the second direction,
wherein the follower pin and the plurality of guide surfaces are configured such that the movement of the second frame member in the first direction and in the second direction relative to the first frame member moves the follower pin along a predefined closed path in a first direction from a starting point back to the starting point, the predefined closed path extending into the cradle, and
wherein the cradle and the follower arm are configured such that when the follower pin is moved into the cradle, further movement of the second frame member in the first direction is prevented until the second frame member is moved in the second direction to remove the follower pin from the cradle.

2. The frame system according to claim 1,
including biasing means for biasing the follower arm in a first rotational direction and into contact with at least one of the plurality of guide surfaces.

3. The frame system according to claim 2,
including at least one movable web extending into the closed path,
wherein the plurality of guide surfaces include a second guide surface and a third guide surface, and
wherein the third guide surface is formed on the at least one movable web and has a first end at an end of the second guide surface.

4. The frame system according to claim 3,
including a fourth guide surface,
wherein the third guide surface is located between the second guide surface and the fourth guide surface.

5. The frame system according to claim 2,
including a pivotable flap extending into the closed path,
wherein the plurality of guide surfaces include a second guide surface and a third guide surface,
wherein the third guide surface is formed on the pivotable flap and has a first end at an end of the second guide surface, and
wherein the pivotable flap is shiftable between a first orientation in which the third guide surface is parallel to or coplanar with the second guide surface and a second orientation in which the third guide surface is angled relative to the second guide surface.

6. The frame system according to claim 5,
wherein the starting point is located on the second guide surface, and
wherein the follower arm and the plurality of guide surfaces are configured such that movement of the second frame member in the second direction slides the follower pin along the second guide surface onto and along the third guide surface and causes the follower arm to move in a second rotational direction opposite the first rotational direction until the follower pin moves past the third guide surface to a location at which the biasing means moves the follower arm in the first rotation direction until the follower pin contacts a first stop surface.

7. The frame system according to claim 6,
wherein the follower arm and the plurality of guide surfaces are configured such that, with the follower pin in contact with the first stop surface, movement of the second frame member in the first direction moves the follower pin into the cradle.

8. The frame system according to claim 7,
wherein the follower arm and the plurality of guide surfaces are configured such that, with the follower pin in the cradle, moving the second frame member in the second direction moves the follower pin to a location at which the biasing means shifts the follower arm in the first rotational direction to move the follower pin into contact with a fifth guide surface.

9. The frame system according to claim 8,
wherein the follower arm and the plurality of guide surfaces are configured such that, with the follower pin in contact with the fifth guide surface, moving the second frame member in the first direction slides the follower pin onto the second guide surface and back to the starting location.

10. The frame system according to claim 8,
wherein the follower arm and the plurality of guide surfaces are configured such that, with the follower pin in contact with the fifth guide surface, moving the second frame member in the first direction slides the follower pin into contact with the pivotable flap to shift the pivotable flap into the second orientation and move the follower pin past the pivotable flap onto the second guide surface and back to the starting location.

11. The frame system according to claim 10,
including at least one sensor element on the follower arm and at least one target element on the second frame member or including at least one sensor element on the second frame member and at least one target element on the follower arm,
wherein the at least one sensor element, when aligned with one of the at least one target elements, is configured to produce an output signal identifying the at least one target element with which the at least one sensor element is aligned.

12. The frame system according to claim 11,
including an actuator configured to shift the second frame member in the first direction and in the second direction,
wherein the actuator is configured to receive the output signal and to start, stop or change direction in response to the output signal.

13. The frame system according to claim 10,
wherein the first, second, fourth and fifth guide surfaces and the first stop surface are formed on a unitary guide body mounted on the second frame member, and
wherein the pivotable flap is mounted on the guide body.

14. The frame system according to claim 13,
wherein a first subset of the plurality of guide surfaces is located inside the closed path and a second subset of the plurality of guide surfaces is located outside the closed path.

15. The frame system according to claim 1,
including at least one sensor element on the follower arm and at least one target element on the second frame member or including at least one sensor element on the second frame member and at least one target element on the follower arm,
wherein the at least one sensor element, when aligned with one of the at least one target elements, is configured to produce an output signal identifying the at least one target element with which the at least one sensor element is aligned.

16. The frame system according to claim 15,
including an actuator configured to shift the second frame member in the first direction and in the second direction,
wherein the actuator is configured to receive the output signal and to start, stop or change direction in response to the output signal.

17. The frame system according to claim 1,
wherein the plurality of guide surfaces are formed on a unitary guide body mounted on the second frame member.

18. The frame system according to claim 17,
including a pivotable flap extending into the closed path,
wherein the pivotable flap is mounted on the guide body.

19. The frame system according to claim 1,
wherein a first subset of the plurality of guide surfaces is located inside the closed path and a second subset of the plurality of guide surfaces is located outside the closed path.

20. The frame system according to claim 1,
including a pivotable flap extending into the closed path,
wherein the plurality of guide surfaces include a second guide surface and a third guide surface,
wherein the third guide surface is formed on the pivotable flap and has a first end at an end of the second guide surface,
wherein the pivotable flap is shiftable between a first orientation in which the third guide surface is parallel to or coplanar with the second guide surface and a second orientation in which the third guide surface is angled relative to the second guide surface,
wherein the starting point is located on the second guide surface,
wherein the follower arm and the plurality of guide surfaces are configured such that movement of the second frame member in the second direction slides the follower pin along the second guide surface onto and along the third guide surface and causes the follower arm to move in a second rotational direction opposite the first rotational direction until the follower pin moves past the third guide surface to a location at which the biasing means moves the follower arm in the first rotation direction until the follower pin contacts a first stop surface,
wherein the follower arm and the plurality of guide surfaces are configured such that, with the follower pin in contact with the first stop surface, movement of the second frame member in the first direction moves the follower pin into the cradle.

21. The frame system according to claim 20,
wherein the follower arm and the plurality of guide surfaces are configured such that, with the follower pin in the cradle, moving the second frame member in the second direction moves the follower pin to a location at which the biasing means shifts the follower arm in the first rotational direction to move the follower pin into contact with a fifth guide surface.
